(19) United States
(12) Patent Application Publication
(10) Pub. No.: US 2019/0055045 A1
(43) Pub. Date: Feb. 21, 2019

(54) Device and Method for Shaping Closed Packages

(71) Applicant: SIG Technology AG, Neuhausen am Rheinfall (CH)

(72) Inventors: Felix Breitmar, Moenchengladbach (DE); Birgit Birninger, Linnich (DE); Matthias Dammers, Alsdorf (DE); Johannes Marx, Aachen (DE); Christoph Mehler, Moenchengladbach (DE); Thomas Vetten, Duesseldorf (DE)

(73) Assignee: SIG Technology AG, Neuhausen am Rheinfall (CH)

(21) Appl. No.: 16/079,662

(22) PCT Filed: Mar. 21, 2017
(86) PCT No.: PCT/EP2017/056659

§ 371 Date: Aug. 24, 2018

(30) Foreign Application Priority Data
Apr. 4, 2016 (DE) 10 2016 106 139.5
May 31, 2016 (DE) 10 2016 109 979.1

(51) Int. Cl. B65B 61/24; B31B 50/00; B31B 50/28; B31B 50/78; B65B 43/32

(52) U.S. Cl. CPC B65B 61/24; B31B 50/006; B65B 43/325; B31B 50/782; B31B 50/28

(57) ABSTRACT

A device for shaping closed packages is depicted and described, including: a base plate for supporting the bottom or the gable of the packages, at least two support elements for supporting the side surfaces or the front surface and the rear surface of the packages and at least two sliding elements for shaping the side surfaces or the front surface and the rear surface of the packages wherein the support elements and the sliding elements include at least one shaped surface on their side assigned to the package. In order to also enable a precise shaping of the packages even in the case of closed packages with complex geometry, it is proposed for at least one of the shaped surfaces to be curved at least in sections. A method for shaping closed packages is also depicted and described.

The invention relates to a device for shaping closed packages, comprising: a base plate for supporting the bottom or the gable of the packages, at least two support elements for supporting the side surfaces or the front surface and the rear surface of the packages and at least two sliding elements for shaping the side surfaces or the front surface and the rear surface of the packages, wherein the support elements and the sliding elements comprise at least one shaped surface on their side assigned to the package.

The invention also relates to a method for shaping closed packages, comprising the following steps: a) providing a closed package, b) providing a device for shaping packages having at least two support elements and having at least two sliding elements, c) inserting the package into the space between the support elements, d) moving the sliding elements from an open position into a closed position to shape the packages, e) moving the sliding elements from a closed position into an open position and f) removing the package from the space between the support elements.

Packages can be produced in different manners and from different materials. A widespread option for production is to produce a cut-out usually comprising fold lines (also called “crease lines”) from the packaging material from which initially a packaging sleeve and ultimately a package results by folding and further steps. This variant has the advantage, inter alia, that the cut-outs can be very flat and thus stacked in a space-saving manner. In this way, the cut-outs or package sleeves can be produced at a different location to the folding and filling of the packaging sleeves. Composite materials are often used as materials, for example a composite made from a plurality of thin layers of paper, cardboard, plastic or metal. Packages of this type are very widespread in particular in the foodstuffs industry.

The production of packages by folding processes has the advantage of a particularly quick and cost-effective production process. Nevertheless, only straight fold lines can actually be generated by folding processes. Special folding tools or post-processing of the package are thus required for generating curved fold lines.

Packages with partially curved fold lines are, for example, known from WO 2009/141389 A2. Devices and methods for producing packages of this type are, for example, known from DE 1 187 178 A, EP 2 586 718 A1, EP 2 586 718 A1 or DE 10 2006 042 506 A1. However, a disadvantage of these devices and methods is that only packages with straight fold edges can be produced. Some of these documents also provide for horizontal processing of the packages such that the packages that are typically standing when being filled have to be rotated after closing. The package is also individually filled and sealed only during or after the deforming in the shaping device (DE 10 2006 042 506 A1). However, this requires complex design to implement since aseptic or sterile conditions often have to prevail when the package is filled and sealed.

Against this background, the object underlying the invention is to enable precise shaping of the packages even in the case of closed packages with complex geometry.

This object is achieved in a device according to the preamble of claim 1 by at least one of the shaped surfaces being curved at least in sections.

This is a device for shaping or forming closed packages. It can be hereby, for example, a package made from a composite material filled with food. The composite material can comprise a plurality of thin layers made from paper, cardboard, plastic or metal, in particular aluminium. The device initially has a base plate for supporting the bottom or the gable of the packages. The package should thus be able to be set down with its bottom or with its gable on the base plate and thus stand perpendicular to the base plate. The device also comprises at least two support elements for supporting the side surfaces or the front surface and the rear surface of the packages. The support elements are preferably arranged at a distance to each other which corresponds, for example, to the width or depth of the package to be supported by them. The device further comprises at least two sliding elements for shaping the side surfaces or the front surface and the rear surface of the packages. Sliding elements are understood to mean elements that can be moved relative to each other; in particular they can be slid. In order to be able to shape (or form) the package, the support elements and the sliding elements comprise at least one shaped surface on their side assigned to the package. The shaped surface is understood to mean the surface that is in contact with the package during the shaping of the package.

According to the invention, provision is made for at least one of the shaped surfaces to be curved at least in sections. At least one of the shaped surfaces is preferably continuously curved. The curving can for example be concave or convex. The curving of one or a plurality of shaped surfaces can also be both concave and convex such that the concave and convex regions of a shaped surface are for example arranged next to or adjacent to each other. The curved shaped surfaces can be shaped surfaces of the support elements and/or shaped surfaces of the sliding elements. Even packages with complex geometries can be shaped by way of the curving of the shaped surfaces. These are in particular packages in which not all fold lines run straight. In particular, such fold lines often do not obtain their definitive, finished shape by way of a single folding, but rather require shaping once again.

In a configuration of the device, provision is made for all shaped surfaces of the support elements and/or all shaped surfaces of the sliding elements to be curved at least in sections. Since not only one shaped surface, but all shaped surfaces of the support elements and/or the sliding elements are curved at least in sections, even packages with particularly complex geometries can be reliably shaped. In particular, packages can be shaped in which complex shapes are supposed to be achieved on a plurality of sides of the package.

According to a further design of the device, provision is made for the support elements to be rigidly connected to the base plate. By connecting both support elements to the same base plate, the distance between both support elements can be particularly precisely adjusted. It can also be ensured that the two support elements run approximately at right angles to the base plate. In spite of the rigid connection, the support elements can be detachably connected to the base plate such that they can be exchanged. This has the advantage that different packages can be shaped on the same device. A rigid connection is thus understood to mean a connection that is unmovable in the open state, i.e. in the operational state.

According to a further configuration of the device, the sliding elements are movably connected to the base plate. By connecting both sliding elements to the same base plate, the movement direction and the movement path of both sliding elements can be particularly precisely adjusted. It can also be ensured that the two sliding elements run approximately at right angles to the base plate. The sliding elements can be detachably connected to the base plate such that they can be exchanged. This has the advantage that different packages can be shaped on the same device.

To this end, it is further proposed for the sliding elements to be movably mounted in guides which are provided in the base plate. By mounting the sliding elements in guides, a particularly precise movement can be achieved. The guides preferably have a linear design. Provision can be made for the guides of two opposing sliding elements to be arranged on the same axis, i.e. they run colinearly. In this way, the counteracting pressure forces are compensated during the shaping of the package such that no rotational torques occur.

A further configuration of the device is characterised by at least four support elements for supporting the side surfaces or the front surface and the rear surface of the packages. As a result of an increased number of support elements, the packages can be held in their position during shaping in an even more precise manner. For example, one edge or one side surface of the package can be assigned to each of the four support elements.

A further design of the device is characterised by at least four sliding elements for shaping the side surfaces or the front surface and the rear surface of the packages. As a result of an increased number of sliding elements, the packages can be shaped in an even more precise manner. For example, one edge or one side surface of the package can be assigned to each of the four sliding elements. Furthermore, it is practical when generating particularly complex package geometries for at least one section (region) of an edge and at least one section (region) of a side surface of the package to be assigned to a sliding element.

In a further development of the device, provision is made for two support elements to be respectively arranged on opposing sides of the package. By way of the opposing arrangement of the support elements, fixing of the package on both sides is achieved which enables exact positioning of the package. Two opposingly arranged support elements can thus fix the package in one movement direction. Four opposingly arranged support elements can thus fix the package in two movement directions. If four support elements are provided, these are preferably aligned at an angle of approximately 90° to each other such that they uniformly enclose the package.

A further configuration of the device makes provision for two sliding elements to be respectively arranged on opposing sides of the package. Pressure can be applied to the package on both sides by way of the opposing arrangement of the sliding elements. Two of the sliding elements are preferably respectively aligned in an opposing manner and arranged on the same axis; they thus run colinearly. In this way, the counteracting pressure forces are compensated during the shaping of the package such that no rotational torques occur.

According to a further design of the device, provision is ultimately made for a stop surface to be provided on at least one support element and/or on at least one sliding element which is arranged such that it serves as a stop for the sliding elements. The stop surfaces should prevent the sliding elements from moving too far between the support elements and in this case damaging or crushing the package. The stop surfaces thus serve to precisely delimit the path of the sliding elements. Stop surfaces can for example be achieved by the sliding elements being somewhat wider at at least one point than the gap between the two adjacent support elements. The provision of stop surfaces also simplifies the driving of the sliding elements. Since the path of displacement of the sliding elements is delimited by the stop surfaces such that the driving of the sliding elements (e.g. electrically or hydraulically or pneumatically) does not require any limitation of travel. This has the advantage of the same drive being able to be used for different packages (and for different sliding elements and/or support elements) without having to be exchanged or adjusted.

The previously described object is also achieved by a method for shaping closed packages. The method comprises the following steps: a) providing a closed package, b) providing a device for shaping packages having at least two support elements and having at least two sliding elements, c) inserting the package into the space between the support elements, d) moving the sliding elements from an open position into a closed position to shape the packages, e) moving the sliding elements from a closed position into an open position and f) removing the package from the space between the support elements. The packages shaped by the method can for example be packages made from composite material filled with food. The composite material can comprise a plurality of thin layers made from paper, cardboard, plastic or metal, in particular aluminium.

The method is characterised in that the packages are shaped by shaped surfaces of which at least one is curved at least in sections. At least one of the shaped surfaces is preferably continuously curved. The curving can for example be concave or convex. The curving of one or a plurality of shaped surfaces can also be both concave and convex such that the concave and convex regions of a shaped surface are for example arranged next to or adjacent to each other. The curved shaped surfaces can be shaped surfaces of the support elements and/or shaped surfaces of the sliding elements. As has already been previously described in connection with the device, even packages with complex geometries can be shaped by way of the curving of the shaped surfaces. These are in particular packages in which not all fold lines run straight. In particular, such fold lines often do not obtain their definitive, finished shape by way of a single folding, but rather require shaping once again.

According to a further development of the method, provision is made for a device according to any one of claims 1 to 10 to be provided in step b). Owing to the shaped surfaces that are curved at least in sections, the previously described device is particularly suitable for performing the method in all depicted configurations.

A further configuration of the method makes provision for the packages to stand vertically on their bottom region or on their gable region in steps d) and e). The vertical alignment of the package has the advantage that the package no longer has to be rotated after filling and sealing, for example laid on the side. This is because most packages are filled either through the (still unsealed) bottom region or through the (still unsealed) gable region. Due to the rotational movements no longer being necessary, the content of the package is preserved, which is desired in particular in the case of sensitive contents.

According to a further configuration of the method, provision is made for the sliding elements to be moved from an open position into a closed position until they impact against the stop surfaces with the support elements. The delimitation of the displacement path by a stop is a constructively simple option for preventing damage to the package. A particular advantage is that the driving of the sliding elements is simplified by the stop surfaces. Since the path of displacement of the sliding elements is delimited by the stop surfaces such that the (e.g. electric or hydraulic or pneumatic) driving of the sliding elements themselves does not require any limitation of travel. This has the advantage of the same drive being able to be used for different packages (and for different sliding elements and/or support elements) without having to be exchanged or adjusted.

A further design of the method lastly makes provision for the package, in particular the gable region of the package, to be arched outwards in the closed position of the sliding elements. In other words, the volume remaining between the sliding elements in the closed position should be somewhat lower than the volume of the closed package. In order to enable this, the package must be able to “avoid” the compression by the sliding elements, which is why one side of the package, preferably the upper side i.e. the gable region, should not be contacted and deformed by the sliding elements. A free space should instead remain at this side of the package which enables an arching of the package outwards, i.e. a convex arching. The package should thus be deformed beyond its finished shape. This measure balances out the ability of the package material to return to its original shape.

The invention is explained in greater detail below by means of a drawing merely depicting a preferred exemplary embodiment. The following are shown in the drawings:

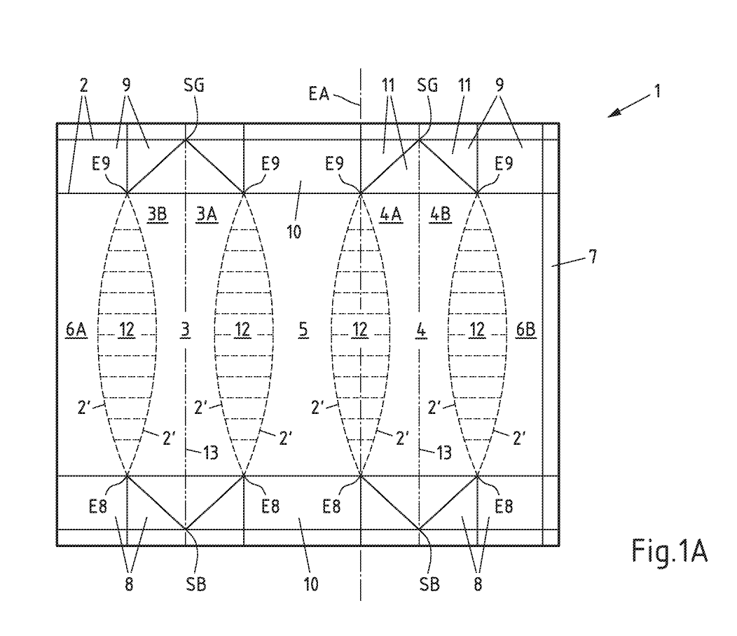

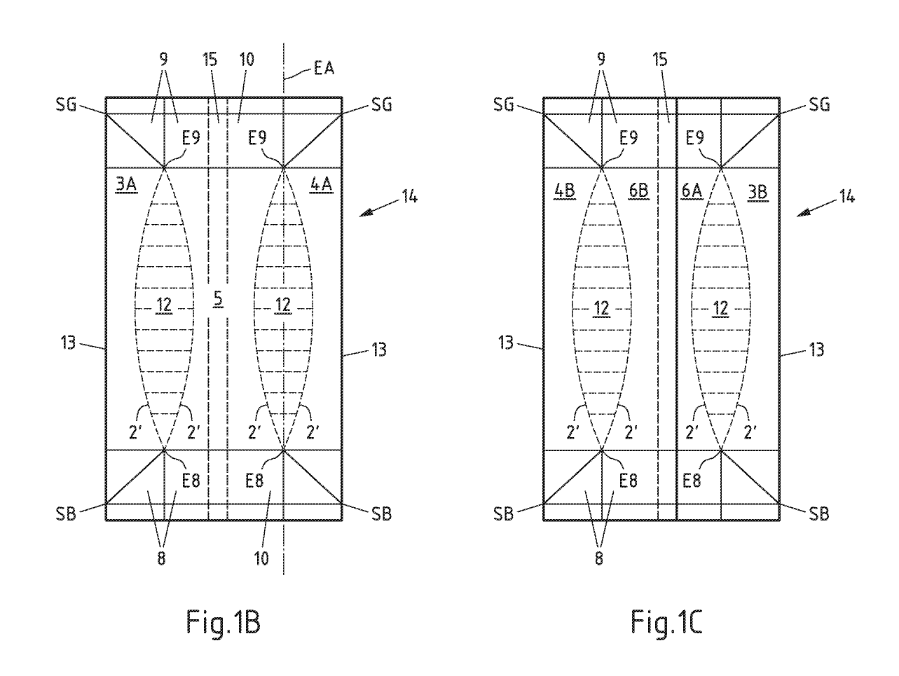

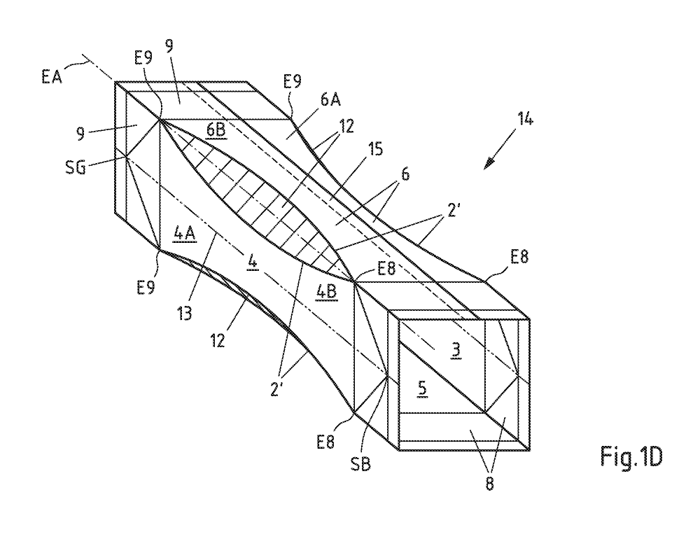

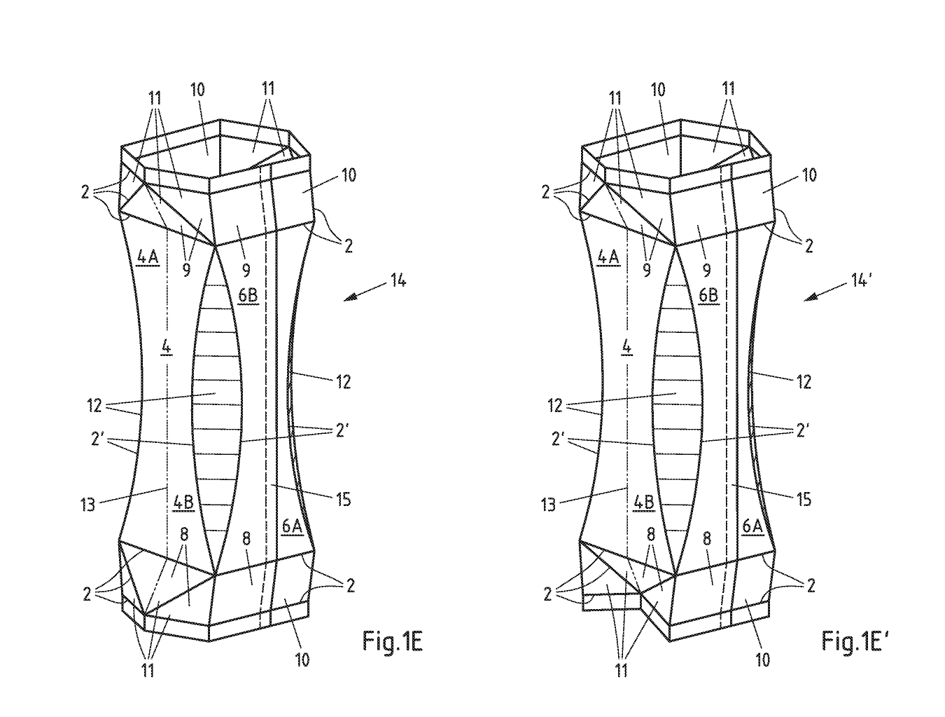

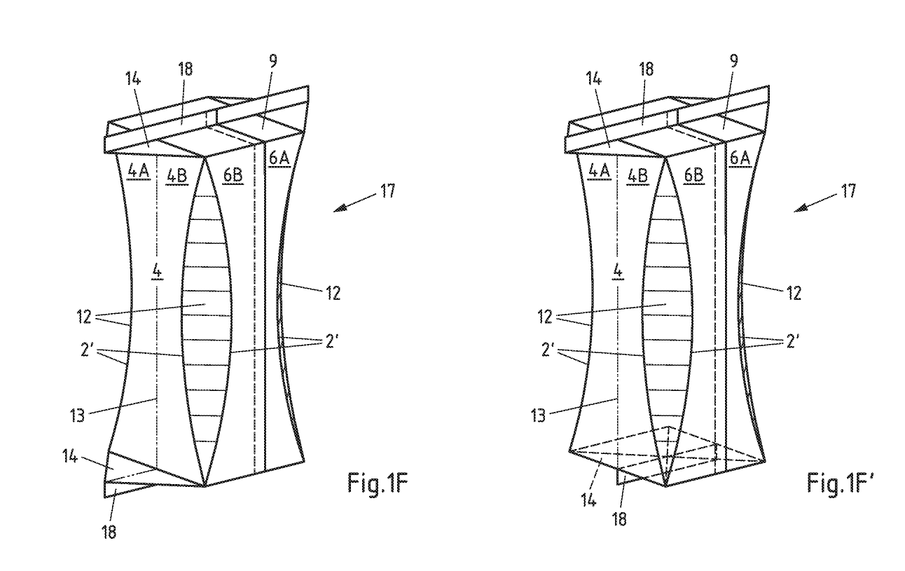

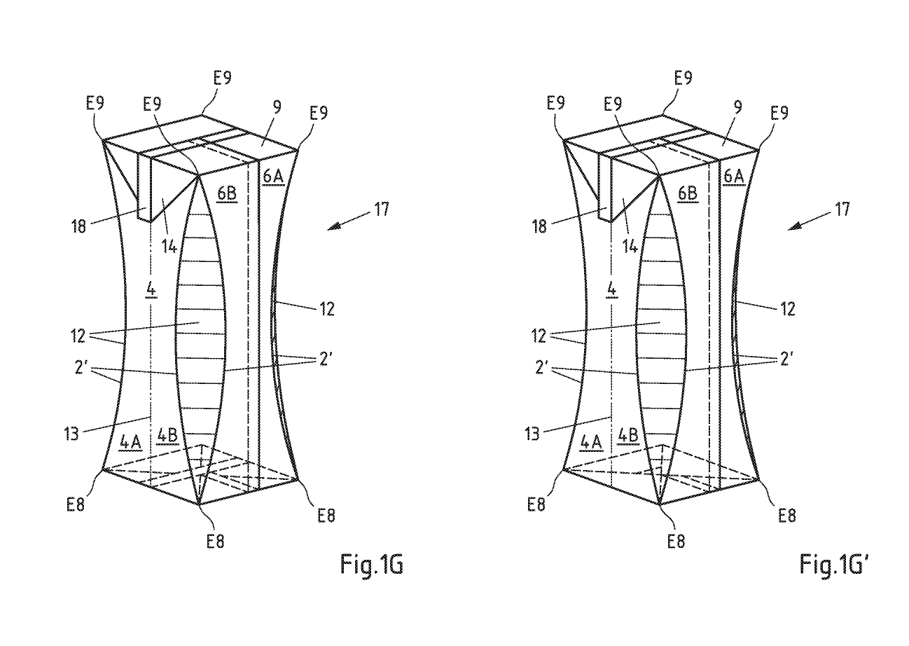

FIG. 1A: a cut-out for folding a package sleeve,

FIG. 1B: a package sleeve, which is formed from the cut-out shown in FIG. 1A, in the flatly folded state in a front view,

FIG. 1C: the package sleeve from FIG. 1B in a rear view,

FIG. 1D: the package sleeve from FIG. 1B and FIG. 1C in the folded state,

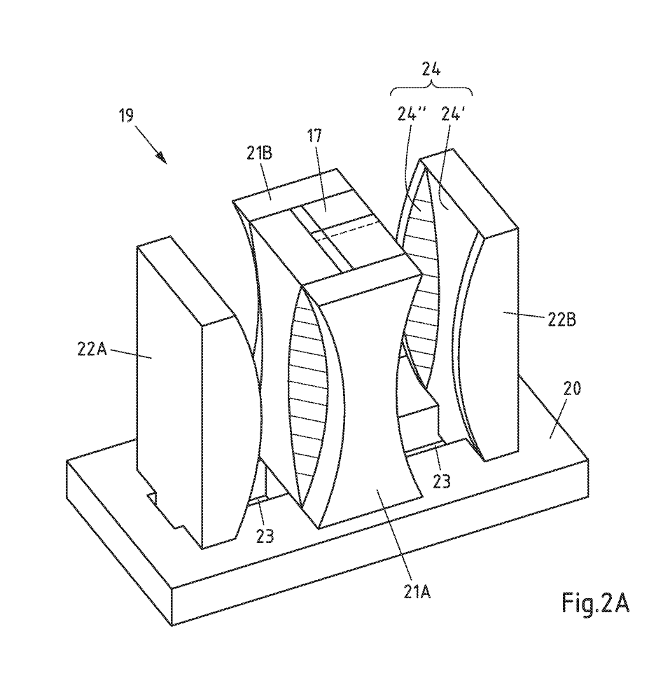

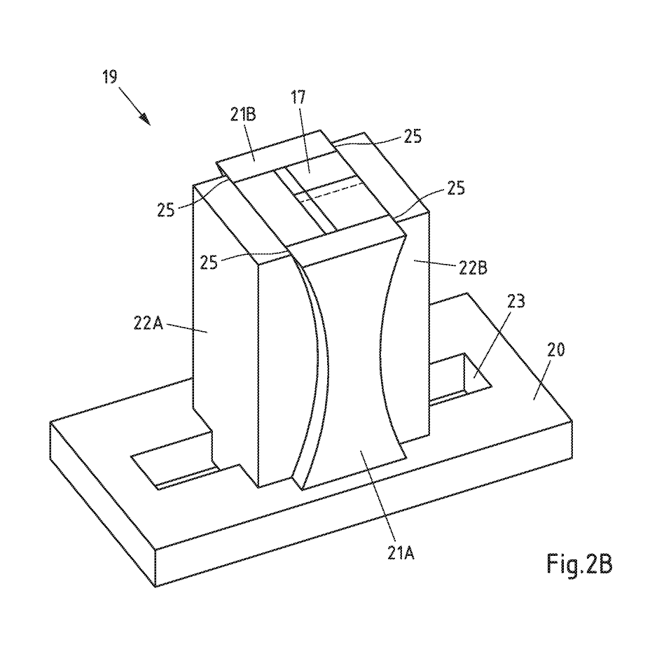

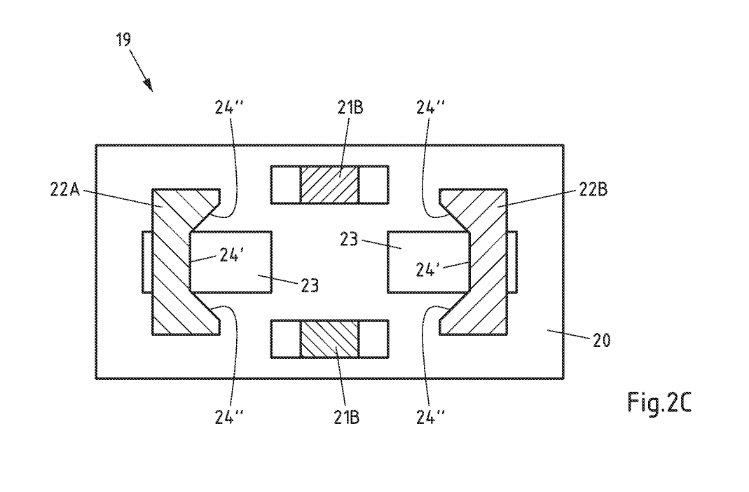

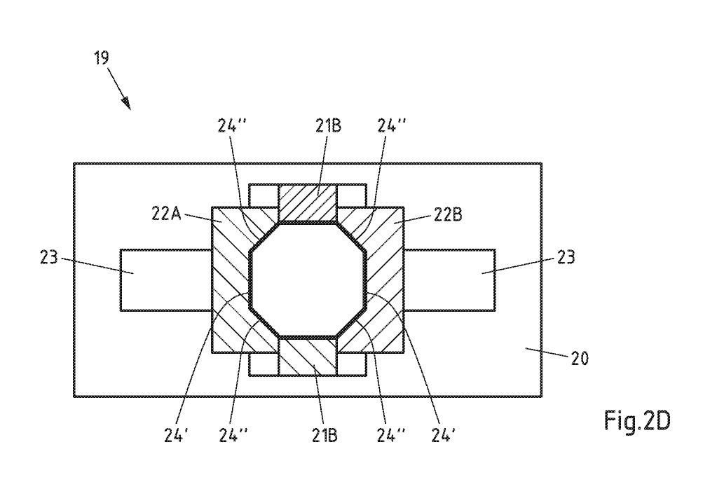

FIG. 1E: the package sleeve from FIG. 2D with pre-folded bottom and gable surfaces,

FIG. 1E′: the package sleeve from FIG. 2D with pre-folded bottom and gable surfaces,

FIG. 1F: a first configuration of a package, which is formed from the package sleeve shown in FIG. 1B, after fusing.

FIG. 1F′: a second configuration of a package, which is formed from the package sleeve shown in FIG. 1B, after fusing.

FIG. 1G: the package from FIG. 1F with ears applied,

FIG. 1G′: the package from FIG. 1F″ with ears applied,

FIG. 2A: a first configuration of a device according to the invention for shaping closed packages in an open position in a perspective view,

FIG. 2B: the device from FIG. 2A in a closed position in a perspective view,

FIG. 2C: the device from FIG. 2A in an open position in the cross-section,

FIG. 2D: the device from FIG. 2A in a closed position in the cross-section,

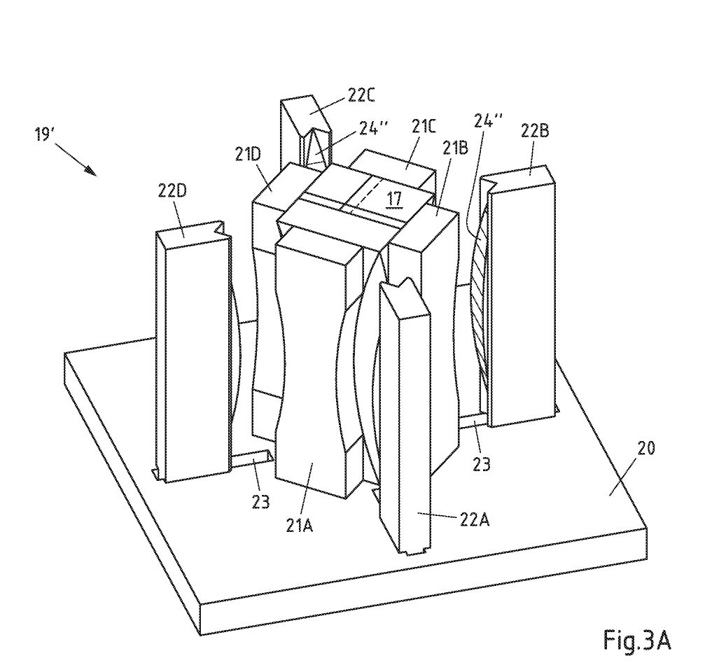

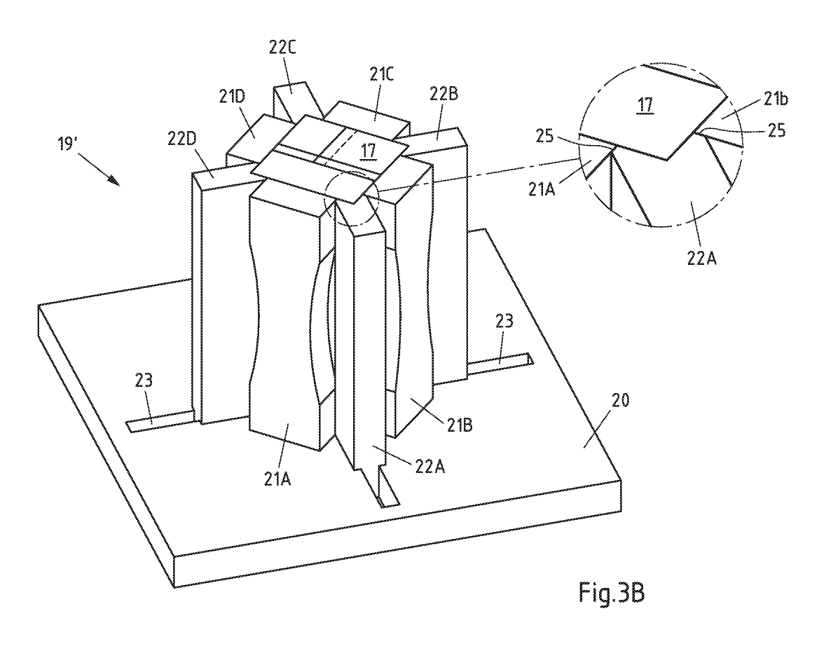

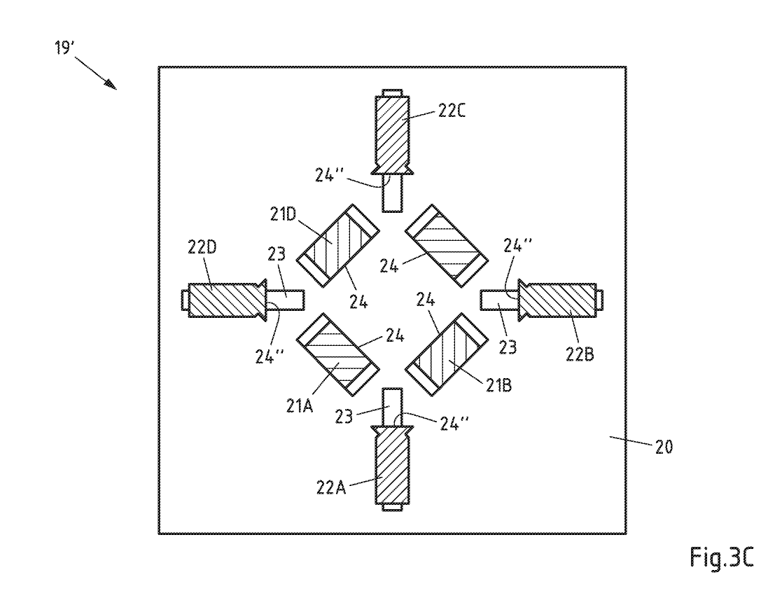

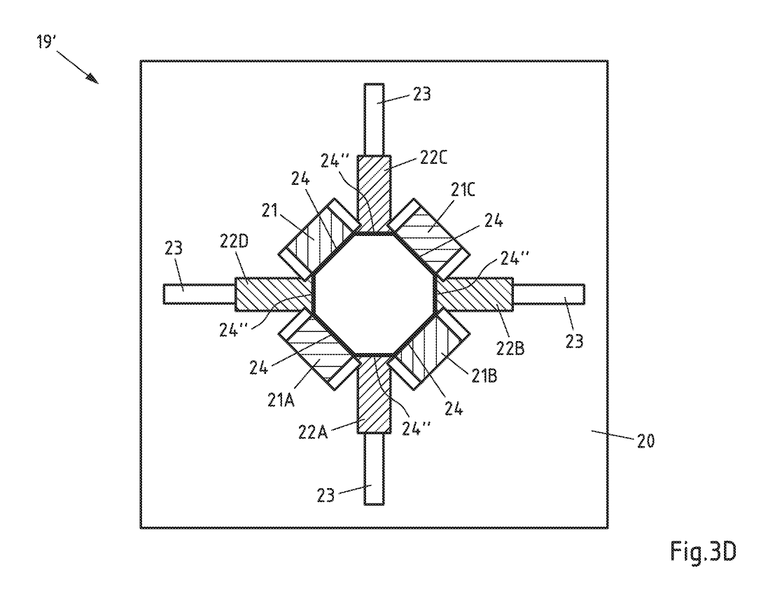

FIG. 3A: a second configuration of a device according to the invention for shaping closed packages in an open position in a perspective view,

FIG. 3B: the device from FIG. 3A in a closed position in a perspective view,

FIG. 3C: the device from FIG. 3A in an open position in the cross-section, and

FIG. 3D: the device from FIG. 3A in a closed position in the cross-section.

FIG. 1A shows a cut-out 1 for folding a package sleeve. The cut-out 1 can comprise a plurality of layers of different materials, for example paper, cardboard, plastic or metal, in particular aluminium. The cut-out 1 comprises a plurality of fold lines 2 which should facilitate the folding of the cut-out 1 and divide the cut-out 1 into a plurality of surfaces. The cut-out 1 can be divided into a first side surface 3, a second side surface 4, a front surface 5, a rear surface 6, a sealing surface 7, bottom surfaces 8 and gable surfaces 9. The bottom surfaces 8 and the gable surfaces 9 respectively comprise rectangular surfaces 10 and triangular surfaces 11. A package sleeve can be formed from the cut-out 1 by the cut-out 1 being folded such that the sealing surface 7 can be connected, in particular fused to the front surface 5.

The four large surfaces (i.e. the two side surfaces 3, 4, the front surface 5 and the rear surface 6) of the cut-out 1 shown in FIG. 1 are not separated from each other by a straight fold line 2 in each case; instead, the four large surfaces 3, 4, 5, 6 are separated from each other by two curved fold lines 2′ in each case, between which one free shaped surface 12 is respectively arranged. The two side surfaces 3, 4 of the cut-out 1 respectively comprise one illusory fold line 13. The two illusory fold lines 13 are straight and run parallel to each other. The illusory fold lines 13 also run through a contact point SB of three adjacent triangular surfaces 11 of the bottom surface 8 and through a contact point SG of three adjacent triangular surfaces 11 of the gable surfaces 9.

The bottom surfaces 8 of the cut-out 1 shown in FIG. 1A comprise four corner points E8 and the gable surfaces 9 comprise four corner points E9. The corner points E8, E9 constitute corner points of the package to be produced from the cut-out 1. A corresponding corner point E9 of a gable surface 9 is assigned to each corner point E8 of a bottom surface 8, whereby it is the corner point E9 which is arranged above this corner point E8 when the package is standing. A corner axis EA runs through two corner points E8, E9 assigned to each other which would correspond to a vertical package edge in a conventional square package. In the cut-out 1 shown in FIG. 1A, there are thus four corner axes EA present, just like in the package sleeve produced therefrom and the package produced therefrom (for reasons of clarity, only one corner axis EA is always marked). No fold lines are provided between the corner points E8 of the bottom surfaces 8 and the corner points E9 of the gable surfaces 9 assigned to them, i.e. along the corner axes EA.

A package sleeve 14, which is formed from the cut-out 1 shown in FIG. 1A, is depicted in the flatly folded state in a front view in FIG. 1B. The regions of the package sleeve already described in connection with FIG. 1A are provided in FIG. 1B with corresponding reference numerals. The package sleeve 14 results from the cut-out 1 by means of two steps: Firstly, the cut-out 1 is folded along the two illusory fold lines 13. Then, the two partial regions 6A, 6B of the divided rear surface 6 are connected in the region of the sealing surface 7 to each other, in particular fused, whereby a longitudinal seam 15 (concealed in FIG. 1B) results. The package sleeve 14 thus has a circumferential structure closed in the circumferential direction with an opening in the region of the bottom surface 8 and with an opening in the region of the gable surface 9. The edge of the longitudinal seam 15 running within the package sleeve 14 is in this case covered. The purpose of the covering of the open cut edge of the composite material is to prevent contact between the content of the package and this layer, in particular the paper layer or cardboard layer contained therein. The covering of the cut edge takes place here by turning over the composite layer after previous peeling. The centrally laid front surface 5 is visible in the front view which is delimited on both sides by fold lines 2′. Partial regions 3A, 4A of the side surfaces 3, 4 are discernible at the sides which are also delimited at the sides by fold lines 2′. The other partial regions 3B, 4B of the side surfaces 3, 4 are on the rear side of the package sleeve 14 and thus concealed in FIG. 2B. Free surfaces 12 are provided between the fold lines 2′. The free surfaces 12 are arranged in the regions of the package sleeve 14 which later form the (non-angular) “edges” of a package.

FIG. 1C shows the package sleeve 14 from FIG. 1B in a rear view. The regions of the package sleeve already described in connection with FIG. 1A and FIG. 1B are provided in FIG. 1C with corresponding reference numerals. The rear view displays the centrally located rear surface 6 which comprises two partial regions 6A, 6B connected by the longitudinal seam 15 and which is delimited on both sides by fold lines 2′. Partial regions 3B, 4B of the side surfaces 3, 4 are discernible at the sides which are also delimited at the sides by fold lines 2′. The other partial regions 3A, 4A of the side surfaces 3, 4 are on the front side of the package sleeve 14 and thus concealed in FIG. 1C. Free surfaces 12 are also provided on the rear side of the package sleeve 14 between the fold lines 2′. The free surfaces 12 are arranged in the regions of the package sleeve 14 which later form the (non-angular) “edges” of a package body.

The package sleeve 14 from FIG. 1B and FIG. 1C is depicted in FIG. 1D in the folded state. The regions of the package sleeve already described in connection with FIG. 1A to FIG. 1C are provided in FIG. 1D with corresponding reference numerals. The folded state can be achieved by a plurality of folding steps: The package sleeve 14 is firstly folded along the fold lines 2′ which are arranged between the four large surfaces 3, 4, 5, 6 and the four free surfaces 12. Secondly, the package sleeve 14 is folded back along the illusory fold lines 13 running through the side surfaces 3, 4. It is folded back approximately 180°. Folding back along the illusory fold lines 13 results in both partial regions 3A, 3B of the first side surface 3 bordering the illusory fold line 13 no longer being located on top of one another, but rather being arranged at least in approximately the same plane. In a corresponding manner, folding back along the illusory fold lines 13 results in both partial regions 4A, 4B of the second side surface 4 bordering the illusory fold line 13 no longer being located on top of one another, but rather being arranged at least in approximately the same plane. The package sleeve 14 is thus folded only in its flat state (FIG. 1B, FIG. 1C) along the illusory fold lines 13; the package sleeve 14 (just like the package to be produced therefrom) in the folded state (FIG. 1D) is, in contrast, no longer folded along the illusory fold lines 13. Hence the name “illusory” fold lines 13.

FIG. 1E shows the package sleeve 14 from FIG. 1D with pre-folded bottom and gable surfaces. The regions of the package sleeve already described in connection with FIG. 1A to FIG. 1D are provided in FIG. 1E with corresponding reference numerals. The pre-folded state designates (as in FIG. 1D) a state in which the fold lines 2′ have been pre-folded both in the region of the bottom surfaces 8 and in the region of the gable surfaces 9. The regions of the bottom surfaces 8 and the gable surfaces 9 which border the front surface 5 and the rear surface 6 (i.e. the rectangular surfaces 12) are folded inwards during the pre-folding and later form the bottom or the gable of the package. The regions of the bottom surfaces 8 and the gable surfaces 9 which border the side surfaces 3, 4 (i.e. the triangular surfaces 11) are folded outwards during the pre-folding and form protruding regions made of excess material which are also designated as “ears” 14 and are applied to the package in a subsequent production step, for example by fusing or adhering processes.

The package sleeve 14′ from FIG. 1D is also depicted in FIG. 1E′ with pre-folded bottom and gable surfaces which is why corresponding reference numerals are also used here. The difference with FIG. 1E is that the triangular surfaces 11 are not folded outwards, but rather inwards.

FIG. 1F shows a package 17, which is formed from the package sleeve 14 shown in FIG. 1B, after fusing. The regions of the package already described in connection with FIG. 1A to FIG. 1E are provided in FIG. 1F with corresponding reference numerals. The package 17 is shown after fusing, i.e. in the filled and sealed state. A fin seam 18 results in the region of the bottom surfaces 8 and in the region of the gable surfaces 9 after fusing. The ears 16 and the fin seam 18 protrude in FIG. 1F. Both the ears 14 and the fin seam 18 are applied in a subsequent production step, for example by adhering or fusing processes.

FIG. 1F″ also shows a package 17, which is formed from the package sleeve 14 shown in FIG. 1B, after fusing. Corresponding reference numerals are thus also used here. The difference with FIG. 1F is that the triangular surfaces 11 have not been folded outwards in the bottom region of the package prior to fusing, but rather have been folded inwards. The “ears” 14 thus do not protrude outwards in the bottom region of the package, but rather extend inwards. This leads to a shorter fin seam 18.

The package 17 from FIG. 1F is depicted with applied ears 14 in FIG. 1G. The regions of the package already described in connection with FIG. 1A to FIG. 1F are provided in FIG. 1G with corresponding reference numerals. In addition to the ears 14, the fin seams 18 are also applied to the package 17. The upper ears 14 arranged in the region of the gable surface 9 are turned downwards and applied flat on the two side surfaces 3, 4. The upper ears 14 are preferably adhered or fused with the two side surfaces 3, 4. The lower ears 14 arranged in the region of the bottom surface 8 are also turned downwards, but are applied flat on the underside of the package 17 which is formed by two rectangular surfaces 10 of the bottom surface 8. The lower ears 14 are also preferably adhered or fused to the package 17, in particular to the rectangular surfaces 10. In the package 17 depicted in FIG. 1G, the front surface 5 and the rear surface 6 are arranged parallel to each other. Likewise, in the package 17, the two side surfaces 3, 4 are arranged parallel to each other. Angles of approximately 90° are formed between respectively two adjacent surfaces of the four large surfaces 3, 4, 5, 6. However, the transition between the four large surfaces 3, 4, 5, 6 (unlike with the package 17 from FIG. 1G) does not take place by way of angular edges, but rather by free surfaces 12 formed in a geometrically complex manner.

The package 17 from FIG. 1F″ is depicted with applied fin seam 18 in FIG. 1G′.

Corresponding 5 reference numerals are thus also used here. The fin seam 18 is turned down and applied flat to the underside of the package 17 which is formed by two rectangular surfaces 10 of the bottom surface 8. The fin seam 18 is preferably adhered or fused to the package 17, in particular to a rectangular surface 10. The difference with FIG. 1G is in the structure of the bottom of the package 17: The ears 14 are arranged below the rectangular surfaces 10 in FIG. 1G and are thus visible from the underside; in contrast, the rectangular surfaces 10 are arranged below the ears 14 in FIG. 1G′ and are thus visible from the underside.

FIG. 2A shows a first configuration of a device 19 according to the invention for shaping closed packages 17 in an open position in a perspective view. The device 19 comprises a base plate 20 on which the package 17 can be set down with its bottom. The device also comprises two support elements 21A, 21B which are fixedly and unmovably connected to the base plate 20 as well as two sliding elements 22A, 22B which are movably connected to the base plate 20. Linear guides 23 are provided in the base plate 20 for the movable mounting of the sliding elements 22A, 22B. The two support elements 21A, 21B respectively comprise one shaped surface 24 (concealed in FIG. 2A) on the insides, i.e. on the sides assigned to the package 17. The two sliding elements 22A, 22B also respectively comprise three shaped surfaces 24 (concealed in FIG. 2A) on the insides, i.e. on the sides assigned to the package 17 of which a centrally arranged shaped surface 24′ should shape the front surface 5 or the rear surface 6 and of which two laterally arranged shaped surfaces 24″ should shape the free shaped surfaces 12 of the package 17. The shape of the shaped surfaces 24, 24′, 24″ corresponds to the negative of the shape to be achieved of the surfaces of the package 17 formed by said shaped surfaces. The package 17 has already been pushed from above between the two rigid support elements 21A, 21B in the position shown in FIG. 2A; however, the two sliding elements 22A, 22B still have no contact with the package 17, which is why the position is designated as the “open” position.

The device 19 from FIG. 2A is shown in the closed position in perspective view in FIG. 2B. The regions of the device already described in connection with FIG. 1A to FIG. 2A are provided in FIG. 2B with corresponding reference numerals. The essential difference with FIG. 2A is that the two sliding elements 22A, 22B have been moved inwards and are now in contact with the package 17. This position is thus designated as the “closed position”. The package 17 is deformed by the contact between the shaped surfaces 24, 24′, 24″ and the package 17 and made into its finished shape. It can be discerned in FIG. 2B that the two sliding elements 22A, 22B are wider than the package 17 and thus comprise a stop surface 25 on both sides. The stop surfaces 25 prevent the two sliding elements 22A, 22B from being able to be pushed between the two support elements 21A, 21B and in this case crushing the package 17.

FIG. 2C shows the device 19 from FIG. 2A in an open position in the cross-section. The regions of the device already described in connection with FIG. 1A to FIG. 2B are provided in FIG. 2C with corresponding reference numerals. The position shown in FIG. 2C corresponds to the position from FIG. 2A. However, for reasons of improved clarity, the package 17 is not depicted in FIG. 2C. The linear course of the two guides 23 as well as the position of the shaped surfaces 24, 24′, 24″ is clearly discernible.

The device 19 from FIG. 2A is depicted in FIG. 2D in a closed position in the cross-section. The regions of the device already described in connection with FIG. 1A to FIG. 2C are provided in FIG. 2D with corresponding reference numerals. The position shown in FIG. 2D corresponds to the position from FIG. 2B. For reasons of improved clarity, the package 17 is also not depicted in FIG. 2D. The circumferential structure of the shaped surfaces 24, 24′, 24″ is clearly discernible which results with the sliding elements 22A, 22B slid inwards.

FIG. 3A shows a second configuration of a device 19′ according to the invention for shaping closed packages 17 in an open position in a perspective view. The structure of the second configuration of the device 19′ matches the structure of the first configuration of the device 19, which is why corresponding reference numerals are also used in FIG. 3A. A difference with the first configuration is that the second configuration of the device 19′ comprises four support elements 21A, 21B, 21C, 21D which are fixedly and unmovably connected to the base plate 20. The second configuration of the device 19′ also comprises four sliding elements 22A, 22B, 22C, 22D which are movably connected to the base plate 20. The four sliding elements 22A, 22B, 22C, 22D are also mounted in a linear guide 23 in the second configuration which is provided in the base plate 20. The four support elements 21A, 21B, 21C, 21D respectively comprise one shaped surface 24 (concealed in FIG. 2A) on the insides, i.e. on the sides assigned to the package 17. The four sliding elements 22A, 22B, 22C, 22D also respectively comprise one shaped surface 24″ (concealed in FIG. 2A) on the insides, i.e. on the sides assigned to the package 17. The shaped surfaces 24 of the four support elements 21A, 21B, 21C, 21D should shape the two side surfaces 3, 4, the front surface 5 and the rear surface 6 of the package 17 and the shaped surfaces 24″ of the sliding elements 22A, 22B, 22C, 22D should shape the free shaped surfaces 12 of the package 17. The shape of the shaped surfaces 24, 24″ corresponds to the negative of the shape to be achieved of the surfaces of the package 17 formed by said shaped surfaces. The package 17 has already been pushed from above between the four rigid support elements 21A, 21B, 21C, 21D in the position shown in FIG. 3A; however, the four sliding elements 22A, 22B, 22C, 22D still have no contact with the package 17 which is why the position is designated as the “open” position.

The device 19′ from FIG. 2A is shown in the closed position in perspective view in FIG. 3B. The regions of the device already described in connection with FIG. 1A to FIG. 3A are provided in FIG. 3B with corresponding reference numerals. The essential difference with FIG. 3A is that the four sliding elements 22A, 22B, 22C, 22D have been moved inwards and are now in contact with the package 17. This position is thus designated as the “closed position”. The package 17 is deformed by the contact between the shaped surfaces 24, 24″ and the package 17 and made into its finished shape. It can be discerned in FIG. 3B that the four sliding elements 22A, 22B, 22C, 22D are wider than the gap between two adjacent support elements 21A, 21B, 21C, 21D, which is why they comprise a stop surface 25 on both sides. The stop surfaces 25 prevent the four sliding elements 22A, 22B, 22C, 22D from being able to be pushed between the four support elements 21A, 21B, 21C, 21D and in this case crushing the package 17.

FIG. 3C shows the device 19′ from FIG. 3A in an open position in the cross-section. The regions of the device already described in connection with FIG. 1A to FIG. 3B are provided in FIG. 3C with corresponding reference numerals. The position shown in FIG. 3C corresponds to the position from FIG. 3A. However, for reasons of improved clarity, the package 17 is not depicted in FIG. 3C. The linear course of the four guides 23 as well as the position of the shaped surfaces 24, 24″ is clearly discernible.

The device 19′ from FIG. 3A is depicted in FIG. 3D in a closed position in the cross-section. The regions of the device already described in connection with FIG. 1A to FIG. 3C are provided in FIG. 3D with corresponding reference numerals. The position shown in FIG. 3D corresponds to the position from FIG. 3B. For reasons of improved clarity, the package 17 is also not depicted in FIG. 3D. The circumferential structure of the shaped surfaces 24, 24″ is clearly discernible which results with the sliding elements 22A, 22B, 22C, 22D slid inwards.

### LIST OF REFERENCE NUMERALS

1: cut-out

2, 2′: fold line

3: first side surface

4: second side surface

5: front surface

6: rear surface

6A, 6B: partial region (of the rear surface)

7: sealing surface

8: bottom surface

9: gable surface

10: rectangular surface

11: triangular surface

12: free shaped surface

13: illusory fold line

14, 14′: package sleeve

15: longitudinal seam

16: ear

17: package

18: fin seam

19, 19′: device

20: base plate

21A, 21B, 21C, 21D: support element

22A, 22B, 22C, 22D: sliding element

23: guide

24, 24′, 24″: shaped surface

25: stop surface

EA: corner axis

E8: corner point (of the bottom surface 8)

E9: corner point (of the gable surface 9)

1. A device for shaping closed packages, comprising:
a base plate for supporting a bottom or a gable of packages;
at least two support elements for supporting side surfaces or a front surface and rear surface of the packages; and
at least two sliding elements for shaping the side surfaces or the front surface and the rear surface of the packages,
wherein the support elements and the sliding elements comprise at least one shaped surface on their side assigned to the package,
wherein at least one of the shaped surfaces is curved at least in sections, and wherein the sliding elements are movably connected to the base plate.

2. The device according to claim 1, wherein all shaped surfaces of the support elements and/or all shaped surfaces of the sliding elements are curved at least in sections.

3. The device according to claim 1, wherein the support elements are rigidly connected to the base plate.

4. (canceled)

5. The device according to claim 1, wherein the sliding elements are movably mounted in guides, which are provided in the base plate.

6. The device according to claim 1, wherein the device further comprises at least four support elements for supporting the side surfaces or the front surface and the rear surface of the packages.

7. The device according to claim 1, wherein the device further comprises at least four sliding elements for shaping the side surfaces or the front surface (and the rear surface of the packages.

8. The device according to claim 1, wherein two support elements are respectively arranged on opposing sides of the package.

9. The device according to claim 1, wherein two sliding elements are respectively arranged on opposing sides of the package.

10. The device according to claim 1, wherein a stop surface is provided on at least one support element and/or on at least one sliding element which is arranged such that the stop surface serves as a stop for the sliding elements.

11. A method for shaping closed packages, comprising:
a) providing a closed package;
b) providing a device for shaping packages having at least two support elements and having at least two sliding elements;
c) inserting the package into a space between the support elements;
d) moving the sliding elements from an open position into a closed position to shape the packages;
e) moving the sliding elements from the closed position into the open position; and
f) removing the package from the space between the support elements;
wherein the packages are shaped by shaped surfaces of which at least one is curved at least in sections, and wherein the packages stand vertically on their bottom region or on their gable region in steps d) and e).

12. The method according to claim 11, wherein a device comprising:
a base plate for supporting a bottom or a gable of packages:
at least two support elements for supporting side surfaces or a front surface and a rear surface of the packages and
at least two sliding elements for shaping the side surfaces or the front surface and the rear surface of the packages,
wherein the support elements and the sliding elements comprise at least one shaped surface on their side assigned to the package
wherein at least one of the shaped surfaces is curved at least in sections, and wherein the sliding elements are movably connected to the base plate.
is provided in step b).

13. (canceled)

14.The method according to claim 11, wherein the sliding elements are moved from the open position into the closed position until the sliding elements impact the stop surfaces with the support elements.

15. The method according to claim 11, wherein the package is arched outwards in the closed position of the sliding elements.

16. The method according to claim 15, wherein the gable region of the package is arched outwards in the closed position of the sliding elements.
